(19) United States
(12) Patent Application Publication
(10) Pub. No.: US 2023/0026654 A1
(43) Pub. Date: Jan. 26, 2023

(54) FILTER MEDIA HOLDER FOR FILTER ASSEMBLIES

(71) Applicant: Cummins Filtration Inc., Nashville, TN (US)

(72) Inventors: Benjamin L. SCHECKEL, Stoughton, WI (US); Bradley A. SMITH, Columbus, IN (US)

(73) Assignee: Cummins Filtration Inc., Nashville, TN (US)

(21) Appl. No.: 17/785,260

(22) PCT Filed: Dec. 7, 2020
(86) PCT No.: PCT/US2020/063600

§ 371 Date: Jun. 14, 2022

Related U.S. Application Data
(60) Provisional application No. 62/949,044, filed on Dec. 17, 2019.

(51) Int. Cl. B01D 46/00; B01D 46/10

(52) U.S. Cl. CPC B01D 46/0005; B01D 46/10; B01D 2273/10

(57) ABSTRACT

A filter media holder for securing a filter media within a filter housing comprises a first grill plate having a plurality of first apertures defined therethrough, and a second grill plate having a plurality of second apertures defined therethrough. In a first configuration, the second grill plate is spaced apart from the first grill plate to allow a filter media to be disposed on the first grill plate or the second grill plate, and in a second configuration, the second grill plate is disposed proximate to the first grill plate such that the filter media is secured between the first grill plate and the second grill plate.

### CROSS-REFERENCED TO RELATED APPLICATIONS

The present application claims priority to and the benefit of U.S. Provisional Application No. 62/949,044, filed Dec. 17, 2019, the entire disclosure of which is hereby incorporated herein by reference.

### TECHNICAL FIELD

The present disclosure relates generally to filter media holders for securing filter elements in filter assemblies that are used with internal combustion engine systems.

### BACKGROUND

During operation of an internal combustion engine various fluids, for example, air, water, lubricants, etc. are used for proper operation of the internal combustion engine. For example, blow-by gases must be vented from a crankcase of an engine. Such gases may include aerosols that have to be removed from the blow by gases before the blow-by gases are expelled into the environment. Filter assemblies including a gas-liquid separator are generally used to remove aerosols from the blow-by gases. In some instances, the blow-by gases may be routed through a filter housing of a filter assembly. A gas-liquid separator filter element may be disposed in the housing for separating the liquids from the gas. The small volume of the filter housing may result in a high blow-by velocity which is not desirable.

### SUMMARY

Embodiments described herein relate generally to systems and methods for securing a filter media in a filter housing using a filter media holder. The filter media holder is configured to serve as an inertial impaction plate for coalescing and separating aerosols from blow-by gases flowing through a small volume of the filter housing. The filter media holder may also serve to diffuse the fluid flow.

In a first set of embodiments, a filter media holder for securing a filter media within a filter housing comprises a first grill plate having a plurality of first apertures defined therethrough, and a second grill plate having a plurality of second apertures defined therethrough. In a first configuration, the second grill plate is configured to be spaced apart from the first grill plate to allow the filter media to be disposed on the first grill plate or the second grill plate, and in a second configuration, the second grill plate is configured to be disposed proximate to the first grill plate such that the filter media is secured between the first grill plate and the second grill plate.

In a second set of embodiments, a filter assembly comprises a filter housing defining a fluid inlet on a sidewall thereof, and a fluid outlet. A filter element is disposed in the filter housing proximate to the fluid inlet. The filter element comprises a filter media holder comprising: a first grill plate having a plurality of first apertures defined therethrough, and a second grill plate having a plurality of second apertures defined therethrough. A filter media is secured between the first grill plate and the second grill plate. The filter element is disposed in the filter housing such that one of the first grill plate or the second grill plate faces the fluid inlet and is oriented perpendicular to the fluid inlet. The filter media holder is configured to diffuse flow of a fluid entering the filter housing through the fluid inlet as the fluid flows through the filter media holder and the filter element.

In a third set of embodiments, a method for installing a filter element within a filter housing of a filter assembly, comprises: providing a filter media holder. The filter media holder comprises a first grill plate having a plurality of first apertures defined therethrough, and a second grill plate having a plurality of second apertures defined therethrough. The method also comprises positioning a filter media on one of the first grill plate or the second plate. One of the first grill plate or the second grill plate is moved proximate to the other one of the first grill plate or the second grill plate until the first grill plate is secured to the second grill plate and the filter media is secured between the first grill plate and the second grill plate. The filter media holder is disposed within the filter housing such that one of the first grill plate or the second grill plate faces an inlet of the filter housing.

It should be appreciated that all combinations of the foregoing concepts and additional concepts discussed in greater detail below (provided such concepts are not mutually inconsistent) are contemplated as being part of the subject matter disclosed herein. In particular, all combinations of claimed subject matter appearing at the end of this disclosure are contemplated as being part of the subject matter disclosed herein.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several implementations in accordance with the disclosure and are therefore, not to be considered limiting of its scope, the disclosure will be described with additional specificity and detail through use of the accompanying drawings.

FIG. 1 is a schematic illustration of a filter assembly, according to an embodiment.

FIG. 2 is a top perspective view of a portion of a filter assembly with a portion of a sidewall of a filter housing of the filter assembly removed to show a filter element disposed therein, according to another embodiment.

FIG. 3 is a top perspective view of a filter media holder of a filter element in a first configuration, according to an embodiment.

FIG. 4 is a top perspective view of the filter media holder of FIG. 3 in the first configuration with a filter media disposed on a second grill plate of the filter media holder.

FIG. 5 is a top perspective view of the filter media holder of FIGS. 3-4 in a second configuration showing the filter media secured between the first grill plate and a second grill plate of the filter media holder.

FIG. 6 is cross-section view of a portion of a filter assembly including the filter housing of FIG. 2, a filter media holder, and showing a set of mounting posts configured to receive corresponding mounting arms of the filter media holder for mounting the filter element in filter housing.

FIG. 7 is a top view of the filter assembly of FIG. 6 with a top cover of the filter housing removed.

FIG. 8 is a top perspective view of a portion of a filter assembly with a portion of a sidewall of a filter housing of the filter assembly removed to show a filter element disposed therein, according to still another embodiment.

FIGS. 9-10 are computational fluid dynamic (CFD) simulations showing the flow path and flow rate of a gas through the filter assemblies of FIG. 2 and FIG. 8, respectively.

FIG. 11 is a schematic flow diagram of a method for securing a filter media in a filter housing, according to an embodiment.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

Embodiments described herein relate generally to systems and methods for securing a filter media in a filter housing using a filter media holder. The filter media holder is configured to serve as an inertial impaction plate for coalescing and separating aerosols from a gas such as air or blow-by gases flowing through a small volume of the filter housing. The filter media holder may also be configured to serve to diffuse the fluid flow.

In particular, embodiments described herein provide a filter assembly configured as a gas-liquid separator for an internal combustion engine that comprises a housing with inlet, outlet, and drain. A filter media holder is disposed between the inlet and outlet. The filter media holder is a separate piece attached to the inside of the housing.

Embodiments described herein also relate to an asymmetric filter media holder for a filter assembly configured as an inertial gas-liquid separator. The filter media holder is open to flow through one or more nozzles which impinge onto one or more open areas of the media holder on an upstream face thereof. The downstream side of a filter media secured within the filter media holder is blocked from direct flow-through by the filter media holder, rectifying the flow going through the media holder.

Embodiments of the filter media holder and filter assemblies including such filter media described herein may provide one or more benefits including, for example: (1) providing a separate piece filter element that is removably disposed within a filter housing; (2) providing a filter element that includes a filter media holder for securing a filter media, which serves as a flow impactor for separating oil from gases as well as a flow diffuser to reduce local flow velocity within the filter housing; and (3) providing a single piece filter media holder that can be easily moved between an open and closed configuration to remove a filter media secured therein.

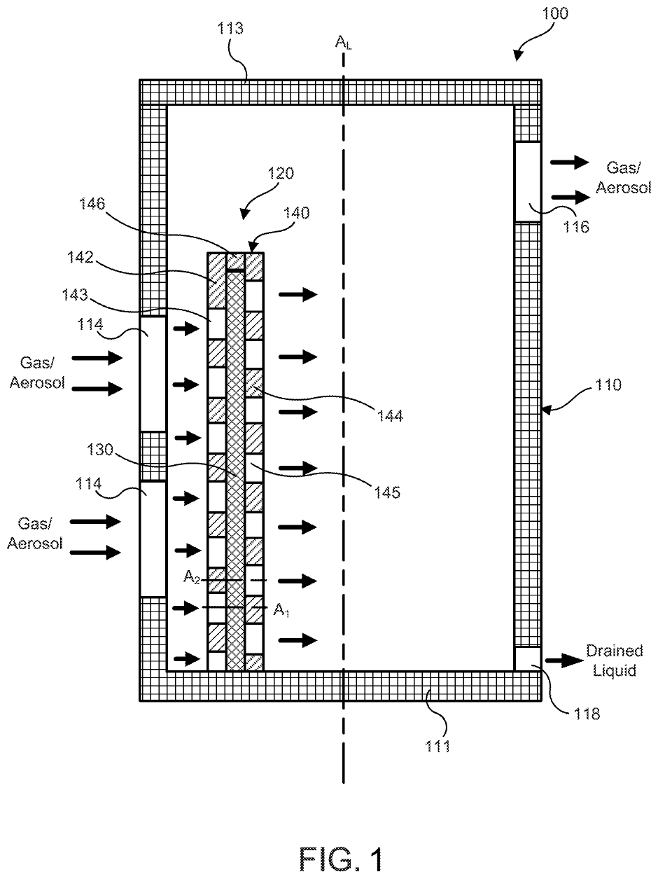

FIG. 1 shows a schematic illustration of a filter assembly 100 that may be configured as a gas-liquid separator, according to an embodiment. For example, the filter assembly 100 may be configured to separate aerosols from a gas (e.g., air or blow-by gases) flowing through the filter assembly 100 and may also be configured to, for example, remove particulate matter included in the gas flowing through the filter assembly 100.

The filter assembly 100 includes a filter housing 110 defining an internal volume within which a filter element 120 is disposed. The filter housing 110 includes a base 111 to which a top cover 113 is coupled. The filter housing 110 defines one or more inlets 114 on a sidewall thereof through which the gas enters the filter housing 110 and an outlet 116 on an opposite sidewall of the base 111, as shown in FIG. 1. In other embodiments, the outlet 116 may be defined in the top cover 113 or any other suitable location of the filter housing 110. In some embodiments, nozzles (not shown) may be disposed in the respective inlets 114 that insert a high velocity stream of the gas into the internal volume of the filter housing 110. A drain 118 may be defined in a lower portion of the sidewall as shown in FIG. 1 or the base 111. Aerosols that may separate from the gas after impinging on the filter element 120 collect on a floor of the base 111 and may be expelled from the filter housing 110 via the drain 118.

The filter element 120 includes a filter media holder 140 securing a filter media 130, as described herein. The filter element 120 is disposed vertically in the filter housing 110. The filter media holder 140 includes a first grill plate 142 having a plurality of first apertures 143 defined therethrough. At least a portion of the plurality of first apertures 143 have a first width. In some embodiments, the plurality of first apertures 143 may have a square shape. In other embodiments, the plurality of first apertures 143 may have any suitable shape, for example, round, rectangular, oval, hexagonal, octagonal, polygonal, any other suitable shape or a combination thereof. The first grill plate 142 may be substantially flat and faces the inlets 114.

The filter media holder 140 also includes a second grill plate 144 having a plurality of second apertures 145 defined therethrough. The plurality of second apertures 145 are offset from the plurality of first apertures 143, i.e., misaligned from the plurality of first apertures 143 when the filter media 130 is secured between the first grill plate 142 and the second grill plate 144.

As described herein, the term “offset” means that respective first apertures 143 of the first grill plate 142 of the first grill plate are positioned relative to second apertures 145 in the second grill plate 144 such that a solid portion of the second grill plate 144 located between the plurality of second apertures 145 faces the plurality of first apertures 143. Thus, the plurality of first apertures 143 define a flow path for the gas passing therethrough such that the gas impacts the solid portions of second grill plate 144 before flowing around the solid portions and through the plurality of second apertures 145 out of the filter media holder 140.

As shown in FIG. 1, when the second grill plate 144 is positioned parallel to the first grill plate 142, a first flow axis A₁ of each of the plurality of first apertures 143 is axially offset from a second flow axis A₂ defined by a corresponding second aperture 145 of the plurality of second apertures 145, as shown in FIG. 1. Particularly, the second flow axis A₂ is vertically offset from the first flow axis A₁ when the first grill plate 142 is disposed substantially parallel to the second grill plate 144, and the filter media holder 140 is vertically oriented in the filter housing 110. In some embodiments, the offset may be substantially equal to a cross-sectional width of the each of the plurality of first apertures 143 or the plurality of second apertures 145. In particular embodiments, the filter media holder 140 may only include the second grill plate 144 such that the first grill plate 142 is excluded.

In some embodiments, the plurality of second apertures 145 may have a square shape. In other embodiments, the plurality of second apertures 145 may have any suitable shape, for example, round, rectangular, oval, hexagonal, octagonal, polygonal, any other suitable shape or a combination thereof. In some embodiments, the second grill plate 144 is separate from the first grill plate 142. In other embodiments, the second grill plate 144 is coupled to the first grill plate 142 and is displaceable relative to the first grill plate 142 without being uncoupled from the first grill plate 142.

The filter media 130 is secured between the first grill plate 142 and the second grill plate 144. Any suitable filter media may be used such as, for example, a coalescing media, a pleated media, a straw media, a tetrahedral filter media or any other filter media. In some embodiments, the filter media 130 is formed into a rectangular shaped block, which is disposed between the first grill plate 142 and the second grill plate 144. The filter media 130 may include notches or cutouts around its perimeter that allow the filter media 130 to conform to contours of various structural features of the first grill plate 142 and/or the second grill plate 144.

The filter element 120 is disposed in the filter housing 110 proximate to the fluid inlets 114. Each of the first grill plate 142 and the second grill plate 144 are substantially flat. The filter element 120 is disposed in the filter housing 110 such that one of the first grill plate 142 or the second grill plate 144 faces the fluid inlet and may be oriented substantially perpendicular to the fluid inlet 114 (e.g., at an angle of 90±5 degrees) such that a flow axis of the gas entering the filter housing 110 is substantially perpendicular to the filter element 120 and impacts the filter element 120 at an angle of about 90 degrees.

At least a portion of the plurality of second apertures 145 may have a second width that may be the same or different from the first width of the plurality of first apertures 143. Furthermore, the filter media holder 140 is configured to diffuse flow of a fluid entering the filter housing 110 through the fluid inlets 114 as the fluid flows through the filter media holder 140 and the filter element 120.

As shown in FIG. 1, the first grill plate 142 faces the fluid inlet 114, and the second grill plate 144 faces away from the fluid inlet 114. In some embodiments, the second width of the plurality of second apertures 145 may be the same, larger, or smaller than the first width of the plurality of first apertures 143. Because the plurality of second apertures 145 are offset from the plurality of first apertures 143, gas passing through the plurality of first apertures 143 and the filter media 130 impacts the solid portion of the second grill plate 144. Thus, the second grill plate 144 serves as an impaction plate for reducing the local flow velocity of the gas impinging thereon. Moreover, as the gas flows through the filter media 130, aerosols present in the gas coalesce on the filter media 130 and collect on the base 111, and may be drained via the drain 118. The gas flows through the plurality of second apertures 145 which further diffuses the flow.

In other embodiments, the filter element 120 may be disposed in the filter housing 110 such that the second grill plate 144 faces the fluid inlet 114 and the first grill plate 142 faces away from the fluid inlet 114. This configuration may provide a better distribution of flow through a cross-section of the filter housing 110, and reduced local velocity.

In some embodiments, the first grill plate 142 is coupled to the second grill plate 144 such that the second grill plate 144 is displaceable relative to the first grill plate 142. In some embodiments, a hinge 146 may couple a first grill plate first end that is located distal from the base 111 to a corresponding second grill plate first end. The second grill plate 144 may be rotatable about the hinge relative to the first grill plate 142 to allow moving of the filter media holder 140 between the first configuration and the second configuration. For example, the second grill plate 144 may be rotated about the hinge 146 relative to the first grill plate 142 to allow removal of a used filter media 130 or positioning of a new filter media 130 on the first grill plate 142. The second grill plate 144 may then be rotated about the hinge 146 until the second grill plate 144 is located approximately parallel to the first grill plate 142 and coupled thereto (e.g., via a snap-fit mechanism, locks, clamps, screws, nuts, bolts, etc.) and the filter media 130 is secured between the first grill plate 142 and the second grill plate 144. Alternatively, the filter media 130 may be placed on the second grill plate 144. The first grill plate 142 may then be rotated about the hinge 146 until the two grill plates 142, 144 are approximately parallel and coupled thereto, with the filter media 130 secured between them.

In some embodiments, the hinge 146 may comprise one or more thin and flexible strips extending from the first grill plate first end to the second grill plate first end. The strips may have a length that corresponds to a thickness of the filter media 130 such that when the second grill plate 144 is located parallel to the first grill plate 142 in the second configuration, the second grill plate 144 is spaced apart from the first grill plate 142 by a distance that corresponds to a thickness of the filter media 130, as shown in FIG. 1. In some embodiments, a plurality of protrusions may be defined on a surface of the first grill plate 142 and/or the second grill plate 144, which is configured to face the filter media 130 when the filter media 130 is disposed between the first grill plate 142 and the second grill plate 144. The plurality of protrusions may impinge on the filter media 130 and secure the filter media 130 between the first grill plate 142 and the second grill plate 144 in the second configuration. Alternatively, the hinge 146 may be designed such that, regardless of a hinge length of the hinge 146, when the first and second grill plates 142, 144 are coupled, the two distal grill plate ends (the two grill plate ends closest to the hinge 146) are spaced apart approximately the thickness of the filter media 130.

In some embodiments, a set of mounting arms are coupled to at least one of the first grill plate 142 or the second grill plate 144. The mounting arms may be configured to engage corresponding mounting pins defined in the filter housing 110 for mounting the filter media holder 140 within the filter housing 110. In some embodiments, the filter media holder 140 may be removably secured in the filter housing 110, for example, via a snap-fit mechanism, screws, nuts, bolts, etc. In other embodiments, the filter media holder 140 may be fixedly secured in the filter housing 110, for example, via adhesives, fusion bonding, or welding.

The filter media holder 140 may be monolithically formed (e.g., with or without the hinge 146). In some embodiments, the filter media holder 140 may be formed from plastic or polymers and may be formed via injection molding. In some embodiments, the filter media holder 140 may be formed from metals (e.g., aluminum) and may be molded, stamped, or forged. In some embodiments, poke-yoke structures, for example, positioning arms, mounting pillars, etc. may be provided in the filter housing 110 for facilitating positioning of the filter element 120 within the filter housing 110.

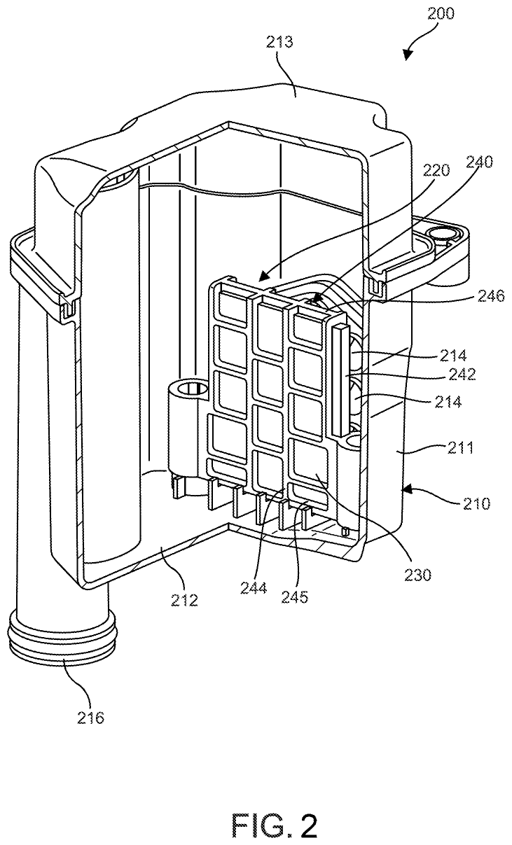

Referring now to FIG. 2, a filter assembly 200 is shown, according to another embodiment. The filter assembly 200 may be configured as a gas-liquid separator, for example, configured to separate aerosols from a gas (e.g., air or blow-by gases) flowing through the filter assembly 200, and may also be configured to filter, for example, particulate matter included in the gas.

The filter assembly 200 includes a filter housing 210 defining an internal volume within which a filter element 220 is disposed. The filter housing 210 includes a base 211 to which a top cover 213 is coupled. The filter housing 210 defines one or more inlets 214 on a sidewall thereof through which the gas enters the filter housing 210, and an outlet 216 for expelling filtered gas from the filter housing 210. The filter housing 210 may be formed from plastics, polymers, any other suitable material or combinations thereof. Nozzles are disposed in the respective inlets 214 that insert a high velocity stream of the gas into the internal volume of the filter housing 210. A drain 218 (FIG. 6) is defined in a floor of the base 211 to allow water or aerosols that may separate from the gas after impinging on the filter element 220 and collect on the floor of the base 211 to be drained from the filter housing 210.

The filter element 220 includes a filter media holder 240 securing a filter media 230, as described herein. The filter media holder 240 includes a first grill plate 242 that is located upstream and faces the inlets 214, and a second grill plate 244 that is located downstream of the first grill plate 242. The first grill plate 242 defines a plurality of first apertures (not shown) and the second grill plate 244 defines a plurality of second apertures 245. In some embodiments, the plurality of first apertures may have a width which is substantially equal to the plurality of second apertures 245 (e.g., within ±10%), and are offset from the plurality of first apertures, as previously described herein with respect to FIG. 1. In some embodiments, the first grill plate 242 may be coupled to the second grill plate 244 via a hinge 246.

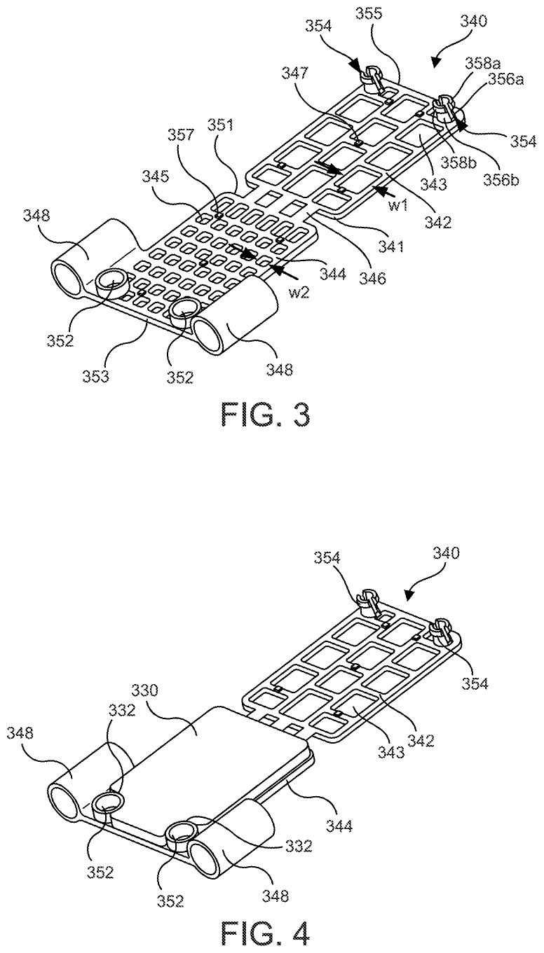

Referring to FIGS. 3-5, a filter media holder 340 is shown according to another embodiment. The filter media holder 340 may be used to secure a filter media 330 within the filter housing 210. FIG. 3 shows the filter media holder 340 in a first configuration with the filter media 330 removed. The filter media holder 340 includes a first grill plate 342 having a plurality of first apertures 343 defined therethrough. At least a portion of the plurality of first apertures 343 have a first width w1 and are generally square in shape, but in other embodiments, may be round, rectangular, oval, hexagonal, octagonal, polygonal, have any other suitable shape or a combination thereof. The first grill plate 342 is substantially flat and is configured to face the fluid inlet 214 of the filter housing 210, when the filter media holder 340 is disposed in the filter housing 210. In other words, the first grill plate 342 is located upstream.

A second grill plate 344 is coupled to the first grill plate 342 such that the second grill plate 344 is displaceable relative to the first grill plate 342 without being uncoupled from the first grill plate 342. In other embodiments, the second grill plate 344 may be separate from the first grill plate 342 and configured to be uncoupled from the first grill plate 342. The second grill plate 344 has a plurality of second apertures 345 defined therethrough. In some embodiments, at least a portion of the plurality of second apertures 345 have a rectangular shape, as shown in FIGS. 3-6. In other embodiments, the plurality of second apertures 345 may have any suitable shape, for example, round, rectangular, oval, hexagonal, octagonal, polygonal, any other suitable shape or a combination thereof. The second grill plate 344 is configured to be disposed downstream of the first grill plate 342.

At least the portion of the plurality of second apertures 345 have a second width w2 that is smaller than first width w1 of the plurality of first apertures 343. The first grill plate 342 is configured to face the fluid inlet 214 and the second grill plate 344 is configured to face away from the fluid inlet 214 when the filter media holder 340 is disposed within the filter housing 210 (i.e., instead of the filter media holder 240). In some embodiments, the first width w1 may be substantially equal to (e.g., within ±10%) or greater than a width (e.g., diameter) of nozzles that are disposed in each of the inlets 214 of the filter housing 210. The plurality of second apertures 345 are offset or misaligned from the plurality of first apertures 343 such that gas flowing through the plurality of first apertures 343 and the filter media 330 impacts the solid portion of second grill plate 344 before flowing through the plurality of second apertures 345.

The first grill plate 342 and/or the second grill plate 344 serve as impaction plates for reducing the local flow velocity of the gas impinging thereon. Gas flows through the plurality of first apertures 343 into the filter media 330, which coalesces and separates water droplets and/or aerosols from the gas, which collect on the floor of base 211 and may be drained via the drain 218. The gas flows through the plurality of second apertures 345 having the smaller second width w2 that diffuses the gas flow. In the other embodiments, the second width w2 may be substantially equal to the first width w1.

The filter media 330 is secured between the first grill plate 342 and the second grill plate 344. Any suitable filter media may be used such as, for example, a coalescing media, a pleated media, a straw media, a tetrahedral filter media, or any other filter media. In some embodiments, the filter media 330 is formed into a rectangular shaped block that is disposed between the first grill plate 342 and the second grill plate 344. While FIGS. 3-7 show the first grill plate 342 and the second grill plate 344 having a generally rectangular shape, in other embodiments, the first grill plate 342 and the second grill plate 344 may have any other shape, for example, circular, elliptical, oval, polygonal, asymmetric, etc. In such embodiment, the filter media 330 may have a shape that corresponds to the shape of the first grill plate 342 and the second grill plate 344.

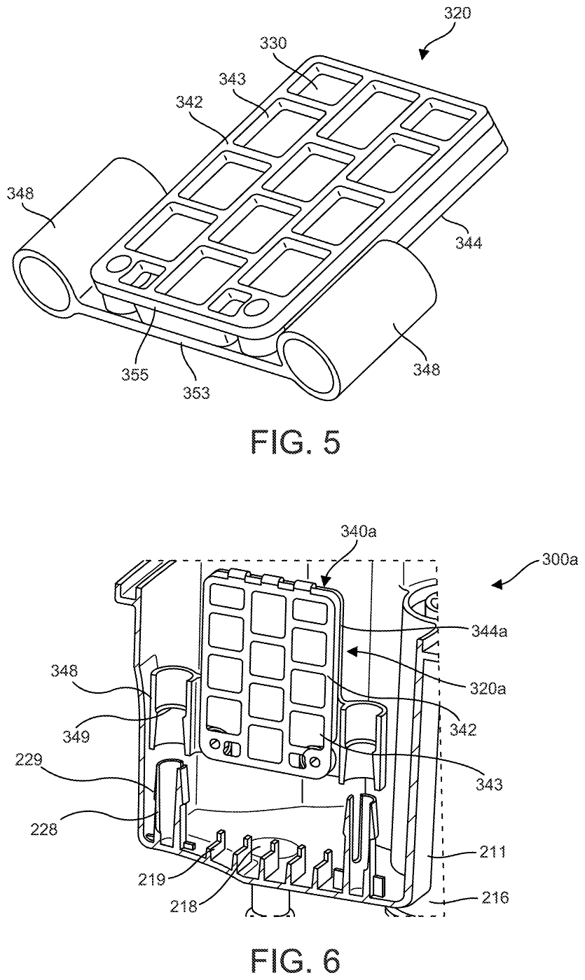

As shown in FIGS. 3-4, a hinge 346 extends from first grill plate first end 341 of the first grill plate 342 that is configured to be located distal from the base 211 to a corresponding second grill plate first end 351 of the second grill plate 344. The second grill plate 344 is rotatable about the hinge 346 relative to the first grill plate 342 to allow moving of the filter media holder 340 between a first configuration shown in FIGS. 3 and 4 in which the second grill plate 344 is located distal from the first grill plate 342, and a second configuration shown in FIG. 5 in which the second grill plate 344 is located proximate to the first grill plate 342 and coupled thereto so as to secure the filter media 330 therebetween and form a filter element 320. For example, the first grill plate 342 may be rotated about the hinge 346 relative to the second grill plate 344 to move the first grill plate 342 away from the second grill plate 344 for allowing removal of a used filter media 330 or positioning of a new filter media 330 on the second grill plate 344. The first grill plate 342 may then be rotated about the hinge 346 until the first grill plate 342 is located approximately parallel to the second grill plate 344 and coupled thereto such that the filter media 330 is secured between the first grill plate 342 and the second grill plate 344. The hinge 346 may comprise one or more thin and flexible strips extending from the first grill plate first end 341 to the second grill plate first end 351. The hinge 346 may have a length that corresponds to a thickness of the filter media 330 such that when the second grill plate 344 is located parallel to the first grill plate 342 in the second configuration, the second grill plate 344 is spaced apart from the first grill plate 342 by a distance that corresponds to a thickness of the filter media 330, as shown in FIG. 5.

In some embodiments, the second grill plate 344 may be removably coupled to the first grill plate 342 in the second configuration. For example, the second grill plate 344 may include a pair of coupling pillars 352 located proximate to a second grill plate second end 353 opposite the second grill plate first end 351. Each of the coupling pillars 352 may extend from a surface of the second grill plate 344 that faces the filter media 330 and have a height corresponding to a thickness of the filter media 330.

Each of the coupling pillars 352 define a channel therethrough configured to receive corresponding coupling pins 354 included in the first grill plate 342 and located proximate to a first grill plate second end 355 opposite the first grill plate first end 341. In some embodiments, each of the coupling pins 354 include a first coupling pin arm 356a and a second coupling pin arm 356b located parallel to the first coupling pin arm 356a and spaced apart therefrom. A first ledge 358a and a second ledge 358b extend radially from an end of the first coupling pin arm 356a and the second coupling pin arm 356b that is opposite the first grill plate 342, the first ledge 358a, and the second ledge 358b extending away from each other.

As the first grill plate 342 is moved into the second configuration, the first coupling pin arm 356a and the second coupling pin arm 356b are inserted through the corresponding coupling pillars 352 until the first ledge 358a and the second ledge 358b extend through the corresponding coupling pillars 352 and snap-lock to a back surface of the second grill plate 344, thereby securing the first grill plate 342 in the second configuration. In some embodiments, the filter media 330 includes notches 332 or cut outs at corners thereof that are proximate to the coupling pillars 352. The notches 332 conform to a periphery of the corresponding coupling pillars 352. In other embodiments, notches or cutouts may also be formed in other locations of the filter media 330 to allow the filter media 330 to conform to various structures of the filter media holder 340.

The first coupling pin arm 356a and the second coupling pin arms 356b may be sufficiently thin so as to be flexible. To release the first grill plate 342 from the second configuration to the first configuration, a user may push the ends of the first coupling pin arm 356a and the second coupling pin arm 356b defining the first ledge 358a and the second ledge 358b towards each other and apply force while pushing the first coupling pin arm 356a and the second coupling pin arm 356b or the first grill plate 342 away from the second grill plate 344. Once the end of the first coupling pin arm 356a and the second coupling pin arm 356b are sufficiently close to each other, the first coupling pin arm 356a and the second coupling pin arm 356b may slide into and out of the corresponding coupling pillars 352 as the first grill plate 342 rotates away from the second grill plate 344.

In some embodiments, a plurality of first protrusions 347 and/or a plurality of second protrusions 357 may extend from surfaces of the first grill plate 342 and the second grill plate 344, respectively which are configured to face the filter media 330 when the filter media 330 is disposed between the first grill plate 342 and the second grill plate 344 in the second configuration. The plurality of first protrusions 347 and the plurality of second protrusions 357 are configured to impinge or press on the filter media 330 so as to secure the filter media 330 between the first grill plate 342 and the second grill plate 344 in the second configuration.

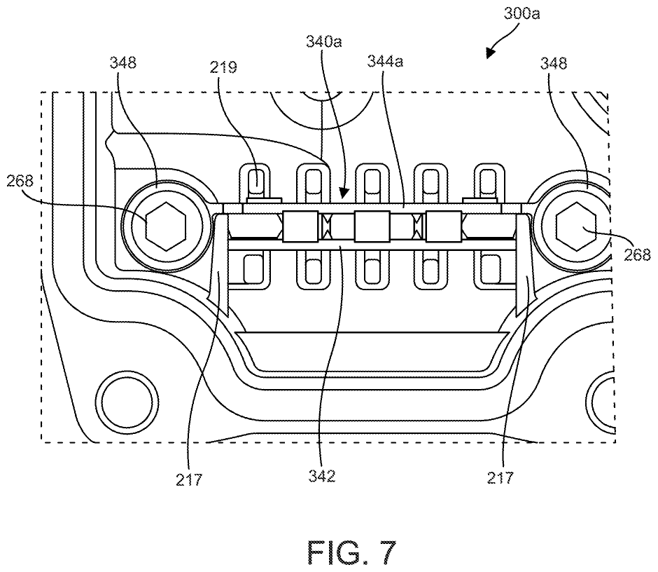

A set of mounting arms 348 may be coupled to the second grill plate 344, for example, to lateral edges thereof proximate to the second grill plate second end 353. For example, FIGS. 6 and 7 show a filter assembly 300a including a filter element 320a including a filter media holder 340a. The filter media holder 340a is substantially similar to the filter media holder 340 and includes the first grill plate 342 located upstream. However, different from the filter media holder 340, a second grill plate 344a located downstream of the first grill plate 342 defines a plurality of second apertures that have a width that is substantially equal to the width w1 of the plurality first apertures 343 of the first grill plate 342. The plurality of second apertures of the second grill plate 344a are offset from the plurality of first apertures 343, as previously described herein.

The second set of mounting arms 348 are coupled to the second grill plate 344/344a. The mounting arms 348 are configured to engage corresponding mounting pins 228 disposed on a floor of the base 211. For example, as shown in FIG. 6, the mounting arms 348 may include hollow cylinders configured to receive corresponding mounting pins 228. In particular embodiments, the mounting arms 348 may be formed by two half segments—one half segment coupled to the first grill plate 342, and the other half segment coupled to the second grill plate 344/344a. Coupling of the first grill plate 342 to the second grill plate 344/344a may also couple the half segments forming the mounting arms 348.

In some embodiments, a circumferential ridge 229 is defined around each of the mounting pin 228. The circumferential ridge 229 is configured to engage a corresponding circumferential ledge 349 defined on an inner surface of each of the mounting arm 348 as the mounting arms 348 are slid around the corresponding mounting pins 228 to mount the filter element 320/320a in the filter housing 210. The circumferential ridge 229 snap-fits to the circumferential ledge 349 securing the filter element 320/320a in the filter housing 210. In some embodiments as shown in FIG. 7, a coupling member 268, for example, a screw or bolt may be inserted through an end of the mounting arm 348 opposite the corresponding mounting pin 228 and coupled to the mounting pin 228. For example, the mounting pins 228 may also be hollow and may define threads on an inner surface thereof that are configured to mate with corresponding threads of the coupling member 268.

The filter media holder 340/340a may be monolithically formed. In some embodiments, the filter media holder 340 may be formed from plastic or polymers and may be formed via injection molding. In some embodiments, the filter media holder 340/340a may be formed from metals (e.g., aluminum) and may be molded, stamped, or forged. In some embodiments, the filter housing 210 may include poke-yoke structures for facilitating positioning of the filter element 320/320a within the filter housing 210. For example, a plurality of standoff pillars 219 as shown in FIGS. 6-7 may extend from the floor of the base 211 up to a desired height. The filter media holder 340/340a may be disposed on the standoff pillars 219 to position the filter element 320/320a at a desired elevation from the floor of the base 211. The standoff pillars 219 may define a notch or a slot to restrict lateral movement of the filter media holder 340/340a within the filter housing 210.

A set of positioning struts 217 may also be disposed on the floor of the base 211 and structured to be located in a space between a mounting arm 348 and a lateral edge of the second grill plate 344/344a. Thus, the mounting arms 348, the mounting pin 228, the standoff pillars 219, and the positioning struts 217 may facilitate positioning of the filter element 320/320a within the filter housing 210 at a specific location within the filter housing 210.

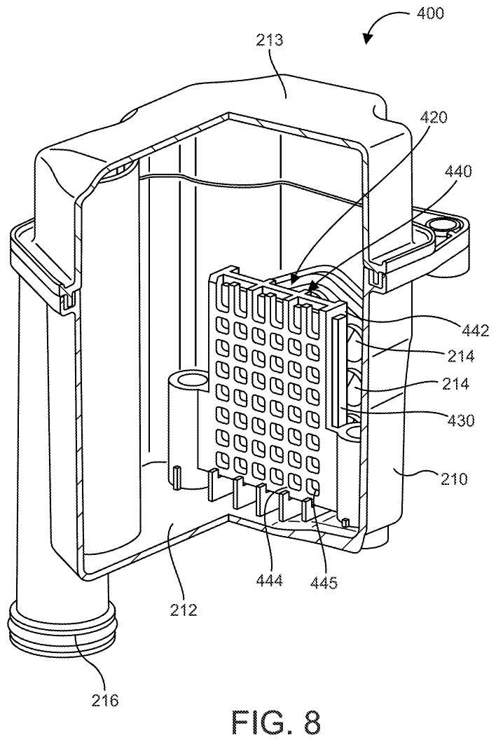

FIG. 8 is a top perspective view a filter assembly 400, according to another embodiment. The filter assembly 400 is substantially similar to the filter assembly 200 with the difference that a filter element 420 including a filter media holder 440 is disposed in the filter housing 210. The filter media holder 440 includes a first grill plate 442 defining a plurality of first apertures (not shown) facing the fluid inlet 214, and a second grill plate 444 defining a plurality of second apertures 445 coupled to the first grill plate 442. The plurality of second apertures 445 may have a second cross-sectional width that is substantially equal to the first cross-sectional width of the plurality of first apertures of the first grill plate 442. A filter media 430 is secured between the first grill plate 442 and the second grill plate 444. In some embodiments, the filter media holder 440 is a monolithic-type media holder that does not include a hinge.

In some embodiments, the width of the plurality of first apertures and the plurality of second apertures 445 may be substantially equal to the second width w2 of the plurality of second apertures 345 of the second grill plate 344 described with respect to the filter media holder 340. The plurality of second apertures 445 are offset from the plurality of first apertures. The smaller second apertures 445 of the second grill plate 444 relative to the plurality of second apertures 245 of the second grill plate 244 shown in FIG. 2 may provide better flow rectification due to a larger area of the solid portion of the second grill plate 444 being in the flow path of the gas through the first grill plate 442 and the filter media 430.

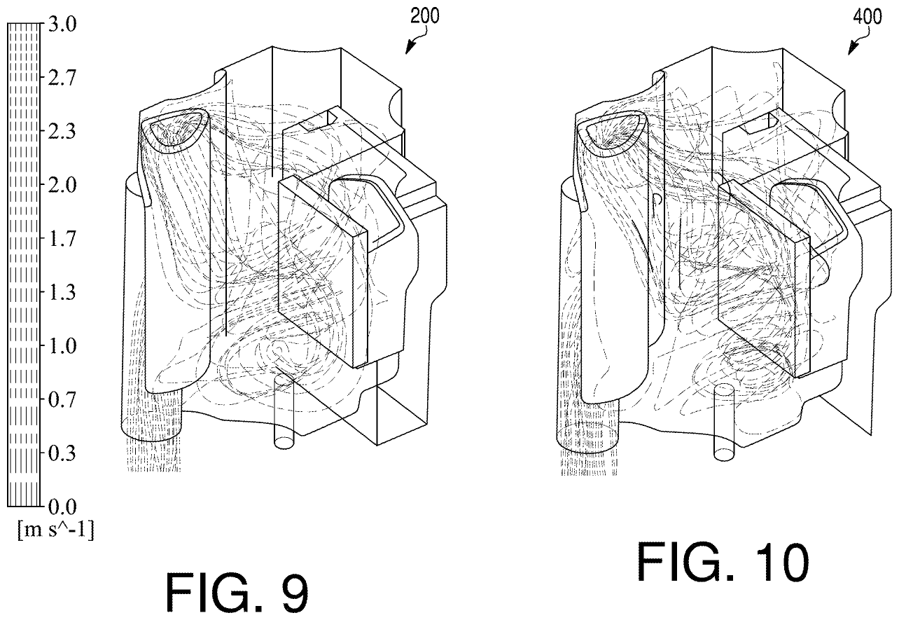

For example, FIGS. 9-10 are computational fluid dynamic (CFD) simulations showing the flow path and flow rate of a gas through the filter assemblies of FIG. 2 and FIG. 8, respectively. High jetting flow is observed through the filter assembly 200 while better distribution of flow is observed through the filter housing 210 of the filter assembly 400.

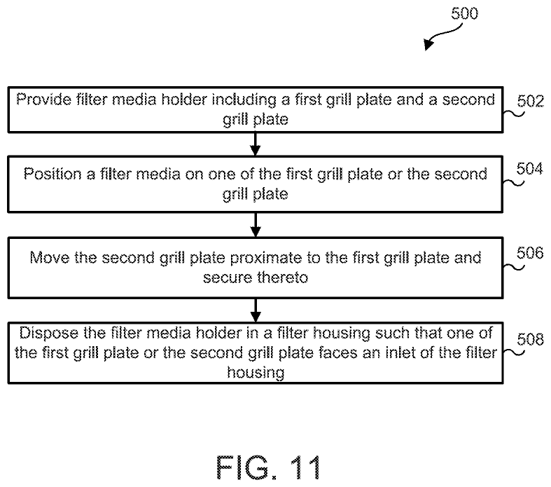

FIG. 11 is a schematic flow diagram of a method 500 for installing a filter element within a filter housing of a filter assembly, according to an embodiment. The method 500 comprises providing a filter media holder (e.g., the filter media holder 140, 240, 340, 440) including a first grill plate (e.g., the first grill plate 142, 242, 342, 442) and a second grill plate (e.g., the second grill plate 144, 244, 344, 444) coupled to the first grill plate, at 502. A first grill plate has a plurality of first apertures (e.g., the first apertures 143, 343) defined therethrough, at least a portion of the plurality of first apertures have a first width.

The second grill plate is coupled to the first grill plate and is displaceable relative to the first grill plate without being uncoupled therefrom. In other embodiments, the second grill plate may be separate from the first grill plate. The second grill plate has a plurality of second apertures (e.g., the second apertures 145, 245, 345, 445) defined therethrough. At least a portion of the plurality of second apertures have a second width that may be the same or different from the first width, as previously described herein. In some embodiments, a hinge (e.g., the hinge 146, 246, 346) couples a first grill plate first end of the first grill plate to a corresponding second grill plate first end of the second grill plate. The second grill plate is rotatable about the hinge relative to the first grill plate to allow moving of the filter media holder between a first configuration in which the second grill plate is located distal from the first grill plate, and a second configuration in which the second grill plate is located proximate to the first grill plate and secured thereto. The second grill plate may be moved away from the first grill plate to move the filter media holder into the first configuration. For example, the second grill plate 144, 244, 344 may be rotated about the hinge 146, 246, 346 to move the second grill plate 144, 244, 344 away from the first grill plate 142, 242, 342 so as to move the filter media holder 140, 240, 340 in the first configuration.

At 504, a filter media (e.g., filter media 130, 230, 330) is positioned on the first grill plate or the second grill plate. For example, the filter media 130, 230, 330 is disposed on the second grill plate 344 as shown in FIG. 4 when the filter media holder 340 is in the first configuration.

At 506, the second grill plate is moved proximate to the first grill plate and may be secured thereto. For example, the second grill plate 144, 244, 344 is rotated about the hinge 146, 246, 346 to move the second grill plate 144, 244, 344 proximate to the first grill plate 142, 242, 342 and secured thereto, as previously described herein. At 508, the filter media holder with the filter media secured therein is disposed in a filter housing such that one of the first grill plate or the second grill plate faces an inlet of the filter housing, as previously described herein.

It should be noted that the term “example” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Other substitutions, modifications, changes and omissions may also be made in the design, operating conditions and arrangement of the various exemplary embodiments without departing from the scope of the embodiments described herein.

While this specification contains many specific implementation details, these should not be construed as limitations on the scope of any embodiment or of what may be claimed, but rather as descriptions of features specific to particular implementations of particular embodiments. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

1. A filter media holder for securing a filter media within a filter housing, comprising:
a first grill plate having a plurality of first apertures defined therethrough; and
a second grill plate having a plurality of second apertures defined therethrough, the plurality of second apertures being offset from the plurality of first apertures,
wherein in a first configuration, the second grill plate is configured to be spaced apart from the first grill plate to allow the filter media to be disposed on the first grill plate or the second grill plate, and in a second configuration, the second grill plate is configured to be disposed proximate to the first grill plate such that the filter media is secured between the first grill plate and the second grill plate.

2. (canceled)

3. The filter media holder of claim 1, wherein the second grill plate is coupled to the first grill plate such that the second grill plate is displaceable relative to the first grill plate without being uncoupled from the first grill plate.

4. The filter media holder of claim 3, wherein the second grill plate is secured to the first grill plate.

5. The filter media holder of claim 3, further comprising:
a hinge coupling a first grill plate first end of the first grill plate to a corresponding second grill plate first end of the second grill plate,
wherein the second grill plate is rotatable about the hinge relative to the first grill plate to allow moving of the filter media holder between the first configuration and the second configuration.

6. The filter media holder of claim 1, wherein at least a portion of the plurality of first apertures define a first cross-sectional width that is different from a second cross-sectional width of the plurality of second apertures.

7. The filter media holder of claim 1, further comprising a plurality of protrusions defined on a surface of the first grill plate and/or the second grill plate, the surface facing the filter media when the filter media is disposed between the first grill plate and the second grill plate, the plurality of protrusions configured to secure the filter media between the first grill plate and the second grill plate in the second configuration.

8. The filter media holder of claim 1, further comprising a set of mounting arms coupled to at least one of the first grill plate or the second grill plate, the mounting arms configured to engage a plurality of corresponding mounting pins defined in the filter housing for mounting the filter media holder within the filter housing.

9. A filter assembly, comprising:
a filter housing defining a fluid inlet and a fluid outlet;
a filter element disposed in the filter housing proximate to the fluid inlet, the filter element comprising:
a filter media holder, comprising:
a first grill plate having a plurality of first apertures defined therethrough,
a second grill plate having a plurality of second apertures defined therethrough, the plurality of second apertures being offset from the plurality of first apertures, and
a filter media secured between the first grill plate and the second grill plate,
wherein the filter element is disposed in the filter housing such that one of the first grill plate or the second grill plate faces the fluid inlet and is oriented perpendicular to the fluid inlet, and
wherein the filter media holder is configured to diffuse flow of a fluid entering the filter housing through the fluid inlet as the fluid flows through the filter media holder and the filter element.

10. (canceled)

11. The filter assembly of claim 9, wherein the filter element is removable from the filter housing, and
wherein in a first configuration, the second grill plate is configured to be spaced apart from the first grill plate to allow the filter media to be removed from, or disposed on the first grill plate or the second grill plate, and in a second configuration, the second grill plate is configured to be disposed proximate to the first grill plate such that the filter media is secured between the first grill plate and the second grill plate.

12. The filter assembly of claim 11, wherein the second grill plate is coupled to the first grill plate such that the second grill plate is displaceable relative to the first grill plate without being uncoupled from the first grill plate.

13. The filter assembly of claim 12, wherein the filter media holder further comprises a hinge coupling a first grill plate first end of the first grill plate to a corresponding second grill plate first end of the second grill plate,
wherein the second grill plate is rotatable about the hinge relative to the first grill plate to allow moving of the filter media holder between the first configuration and the second configuration.

14. The filter assembly of claim 9, wherein at least a portion of the plurality of first apertures define a first cross-sectional width that is different from a second cross-sectional width of the plurality of second apertures.

15. The filter assembly of claim 9, wherein the filter media holder further comprises a plurality of protrusions defined on a surface of the first grill plate and/or the second grill plate, the surface facing the filter media when the filter media is disposed between the first grill plate and the second grill plate, the plurality of protrusions configured to secure the filter media between the first grill plate and the second grill plate in the second configuration.

16. The filter assembly of claim 9, wherein the filter media holder further comprises a set of mounting arms coupled to at least one of the first grill plate or the second grill plate, the mounting arms configured to engage a plurality of corresponding mounting pins defined in the filter housing for mounting the filter media holder within the filter housing.

17. The filter assembly of claim 9, wherein the filter housing comprises a plurality of standoff pillars extending from a base of the filter housing into the filter housing,
wherein the filter media holder is disposed on the plurality of standoff pillars.

18. A method for installing a filter element within a filter housing of a filter assembly, the method comprising:
providing a filter media holder, comprising:
a first grill plate having a plurality of first apertures defined therethrough, and
a second grill plate having a plurality of second apertures defined;
positioning a filter media on one of the first grill plate or the second grill plate;
moving one of the first grill plate or the second grill plate proximate to the other one of the first grill plate or the second grill plate until the first grill plate is secured to the second grill plate and the filter media is secured between the first grill plate and the second grill plate; and
disposing the filter media holder within the filter housing such that one of the first grill plate or the second grill plate faces an inlet of the filter housing.

19. The method of claim 18, wherein the second grill plate is coupled to the first grill plate such that the second grill plate is displaceable relative to the first grill plate without being uncoupled from the first grill plate.

20. The method of claim 19, wherein the filter media holder further comprises a hinge coupling a first grill plate first end of the first grill plate to a corresponding second grill plate first end of the second grill plate,
wherein the second grill plate is rotatable about the hinge relative to the first grill plate so as to allow moving of the one of the first grill plate or the second grill plate proximate to the other one of the first grill plate or the second grill plate.
